(19) United States
(12) Patent Application Publication
(10) Pub. No.: US 2015/0257518 A1
(43) Pub. Date: Sep. 17, 2015

(54) PERSONAL GRIP COVER

(71) Applicant: Don Charles Burkman, Osceola, WI (US)

(72) Inventor: Don Charles Burkman, Osceola, WI (US)

(21) Appl. No.: 14/656,112

(22) Filed: Mar. 12, 2015

Related U.S. Application Data
(60) Provisional application No. 61/952,436, filed on Mar. 13, 2014.

(51) Int. Cl. A45F 5/10; B25G 1/02

(52) U.S. Cl. CPC A45F 5/10; B25G 1/02; A45F 5/1046; A45F 2005/1053

(57) ABSTRACT

A personal grip cover allows a user to lift and carry objects such as luggage, shopping bags, briefcases, ladders, and the like, or to grip a steering wheel or handles of exercise equipment, without causing pain or distress to the user's hands or fingers. The personal grip cover is a tubular body of a rubber material having a durometer of about 50. The tubular body has a generally oval, kidney shaped, or circular cross section with a hollow core and with a longitudinal slot that extends the entire length of the tubular body. The personal grip cover can be opened along the slot to allow the user to apply the tubular body over the handle of a luggage piece, a shopping bag, a briefcase, a purse, or other object, or even a steering wheel. The tubular body cushions the user's hand and fingers when a user lifts and carries the object.

### CROSS-REFERENCE TO RELATED APPLICATION(S)

This application claims priority to U.S. Provisional Application No. 61/952,436, filed on Mar. 13, 2014, and entitled “PERSONAL HANDLE COVER,” which is hereby incorporated by reference.

### BACKGROUND

Carrying heavy bags while shopping, traveling, going to the beach, or other activities can be very hard on a person's hands or fingers. The handles of luggage, shopping bags, briefcases, and other objects can cause nerve damage, and can be especially problematic for persons with carpel tunnel problems. Similar issues can result from gripping a steering wheel of a vehicle for long periods of time.

Devices have been proposed in the past for use in lifting heavy bags or other objects. These devices often have used hook-and-loop fasteners or snaps to attach the device to the handle of a bag or other object that is going to be lifted or carried. These previous devices have often been hard to open and close, and have not provided adequate or comfortable cushioning to the hands or fingers of the user.

### SUMMARY

A personal grip cover comprises a tubular body of a rubber material having a durometer of about 50. The tubular body has a generally oval, kidney shaped, or circular cross section with a longitudinal slot that extends the entire length of the tubular body.

In some embodiments, the tubular body has a wall thickness of about 3/16 inch to about 5/16 inch, a length of about 3 inches to about 5 inches. The tubular body may have a width of about 1 to about 1 1/4 inches, and a height of about 1 3/4 to about 2 inches, or may have a circular cross section with an inner diameter of 1 3/8 inches.

### BRIEF DESCRIPTION OF THE DRAWINGS

FIG. 1A is a top perspective view of a personal grip cover.

FIG. 1B is a perspective end view of the personal grip cover of FIG. 1A.

FIG. 1C is a perspective view of the personal grip cover of FIGS. 1A and 1B showing the personal grip cover pried open along the longitudinal slot.

FIG. 2 shows the personal grip cover applied to a beach bag.

FIG. 3 shows the personal grip cover applied to a leather purse handle.

FIG. 4 shows the personal grip cover applied to the handles of a paper shopping bag provided by a store.

FIG. 5 shows the personal grip cover applied to the handle of computer luggage.

FIG. 6 shows the personal grip cover applied to the handles of a plastic shopping bag.

FIG. 7 shows the personal grip cover applied to the handles of a fabric shopping bag.

FIG. 8 shows the personal grip cover applied to a vehicle steering wheel.

FIG. 9 is a perspective view of the personal grip cover of FIG. 8.

FIG. 10 shows the personal grip cover applied to an exercise machine.

### DETAILED DESCRIPTION

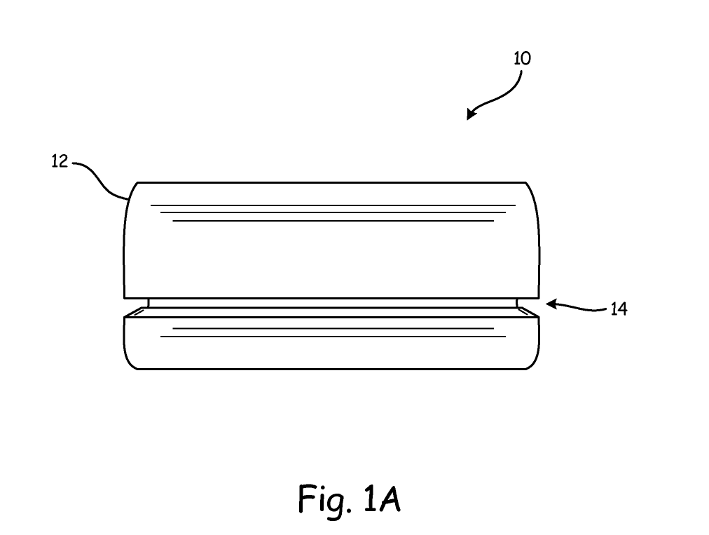

FIGS. 1A-1C show personal grip cover 10, which can be applied to a variety of different handles to allow a user to more comfortably handle and carry luggage, shopping bags, briefcases, ladders, or other objects. Personal grip cover 10 is a tubular body 12 made of rubber material, such as silicone rubber with a durometer of about 50. Tubular body 12 has a length of about 3 inches, 4 inches, or 5 inches to match the palm width of the person who will be using personal grip cover 10. Longitudinal slot 14 extends along the entire length of tubular body 12 to allow the personal grip cover 10 to be opened and inserted over the handle or other object that is to be gripped by a person. Tubular body 12 has a generally oval or kidney shaped cross section with hollow core 16, as best shown in FIG. 1B. The wall thickness of tubular body 12 is between about 3/16 inch and about 5/16 inch. A wall thickness of about 1/4 inch has been found to work very well.

In one embodiment, tubular body 12 has a width of about 1 to 1 1/4 inches, a height of about 1 3/4 to 2 inches, and a length of about 3 inches to about 5 inches depending upon the size of the hand of the person who will be using it. In other embodiments, tubular body 12 may have a cross sectional shape that is a generally circular profile.

The softness (durometer of about 50) and the cross sectional shape of tubular body 12 both help to provide user comfort. The use of silicone rubber provides a product with a long lifetime without any cracking of the rubber material as a result of the opening and closing of the personal grip cover 10.

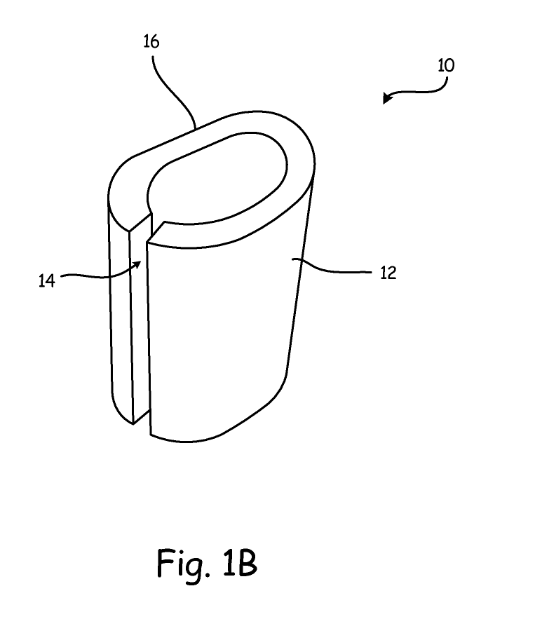

Personal grip cover 10 can be used with a wide variety handle sizes and shapes. FIGS. 2-9 illustrate the versatility of personal grip cover with a variety of different handle types and sizes, and with a variety of different objects being carried.

FIG. 2 shows personal grip cover 10 applied to handle 20 of beach bag 22. Cover 10 is applied to handle 20 by prying open tubular body 12 along longitudinal slot 14. As shown in FIG. 2, longitudinal slot 14 is positioned so that it is facing upward while it is being gripped. That allows the solid portion of tubular body 12 to extend under handle 20. In FIG. 2, longitudinal slot 14 is slightly open. The width of the opening of slot 14 will depend upon the physical size of handle 20.

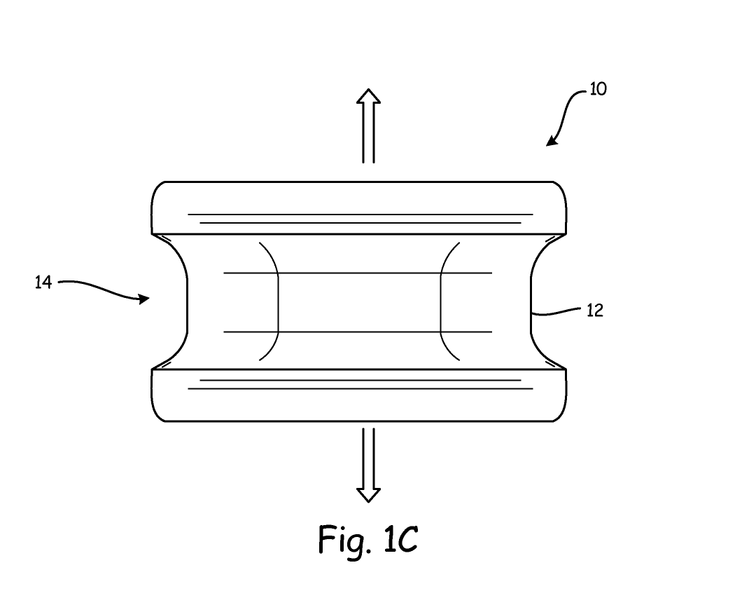

FIG. 3 shows personal grip cover 10 applied to leather handle 30 of leather purse 32. Handle 32 is formed by a pair of leather straps 34A and 34B.

In FIG. 3, longitudinal slot 14 is once again facing upward. The width of opening of slot 14 in FIG. 3 is larger than the width of opening in FIG. 2. That is because the width of straps 34A and of handle 30 in FIG. 3 is greater than the width of handle 20 shown in FIG. 2. FIGS. 2 and 3 illustrate how personal grip cover 10 can accommodate handles of differing widths.

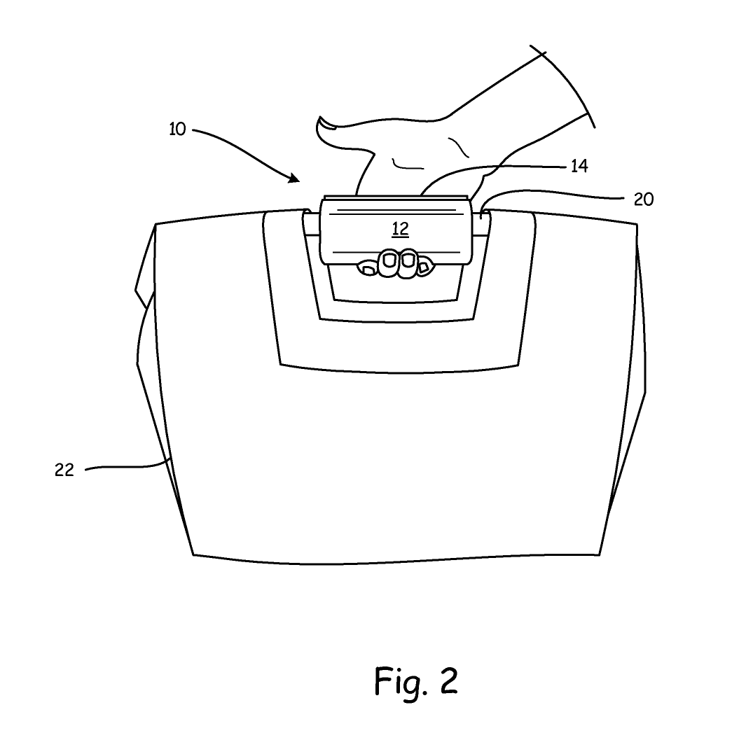

FIG. 4 is a top view showing personal grip cover 10 applied to handle 40 of paper shopping bag 42. Handle 40 is formed by a pair of straps 44A and 44B. The gap of longitudinal slot 14 can be seen in FIG. 4. Once again, slot 14 is positioned to face upward, so that tubular body 12 wraps under handle 40 when bag 42 is being carried.

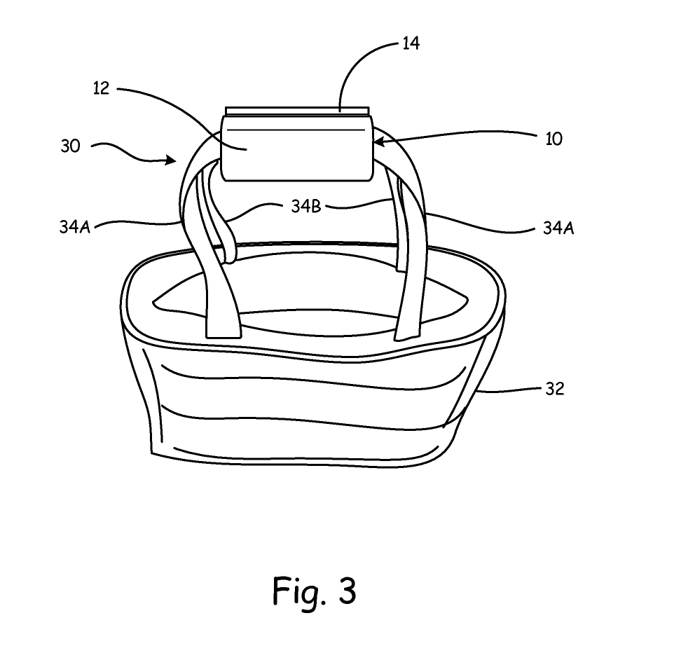

FIG. 5 shows personal grip cover 10 applied to handle 50 of luggage 52. Tubular body 12 extends under handle 50. Longitudinal slot 14 is wider than shown in previous FIGS. 2-4 because handle 50 of luggage 52 is wider.

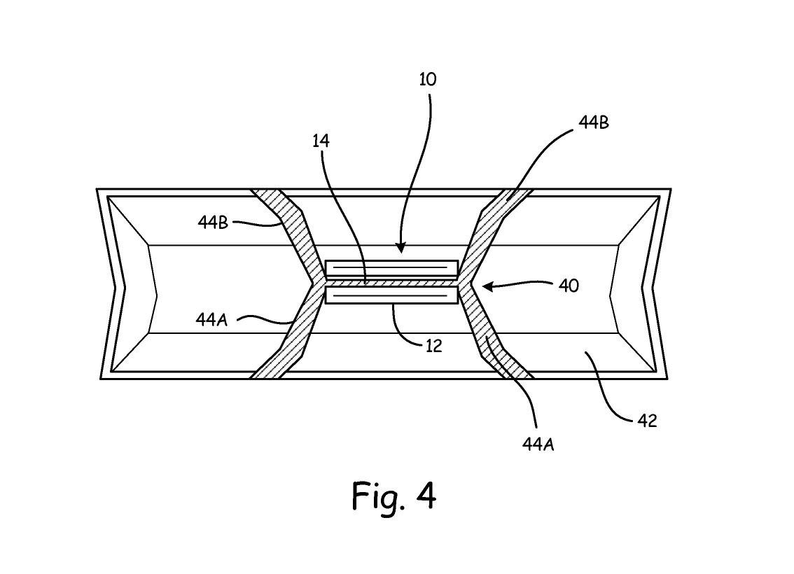

FIG. 6 shows personal grip cover 10 applied to handle 60 of plastic shopping bag 62. Shopping bag 62 includes a pair of loops 64A and 64B at its upper end which together form handle 60. Personal grip cover 10 is open along longitudinal slot 14 to allow loops 64A and 64B to be inserted into hollow core 16. Longitudinal slot 14 is positioned at the top of personal grip cover 10, so that tubular body 12 extends below handle 60.

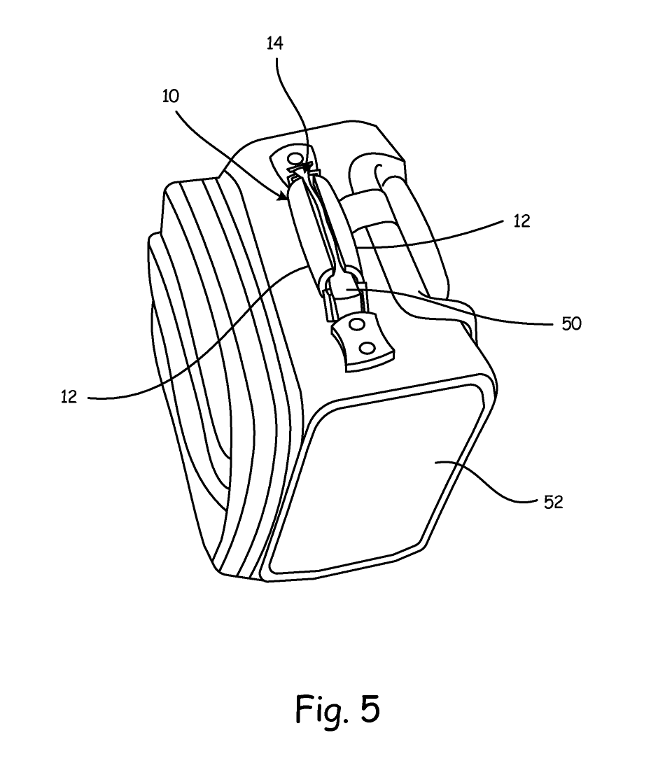

FIG. 7 shows personal grip cover 10 applied to handle 70 of fabric shopping bag 72. Handle 70 is formed by a pair of fabric straps 74A and 74B. Handle cover 10 works in the same fashion described with respect to FIGS. 2-6.

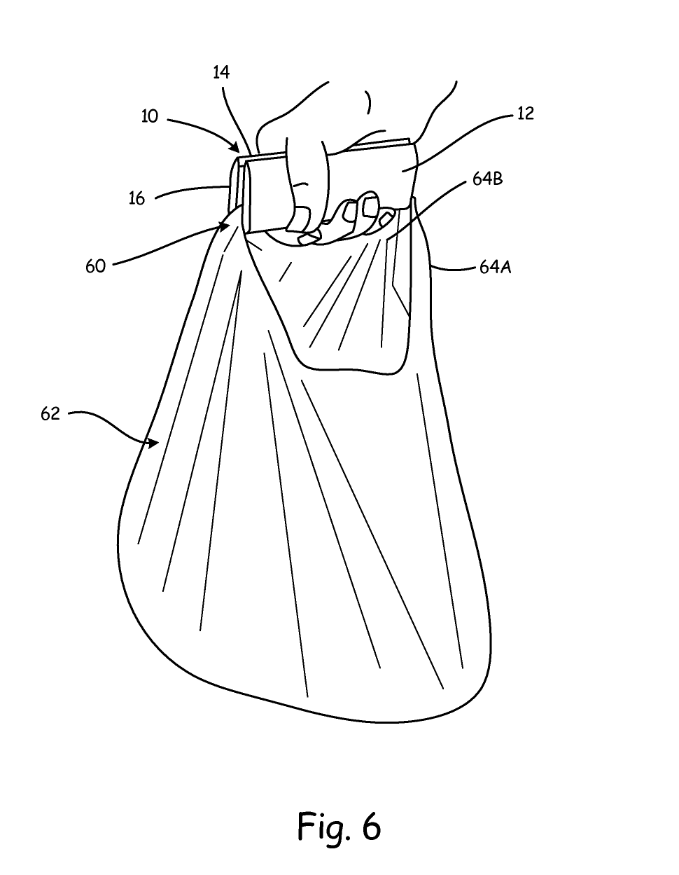

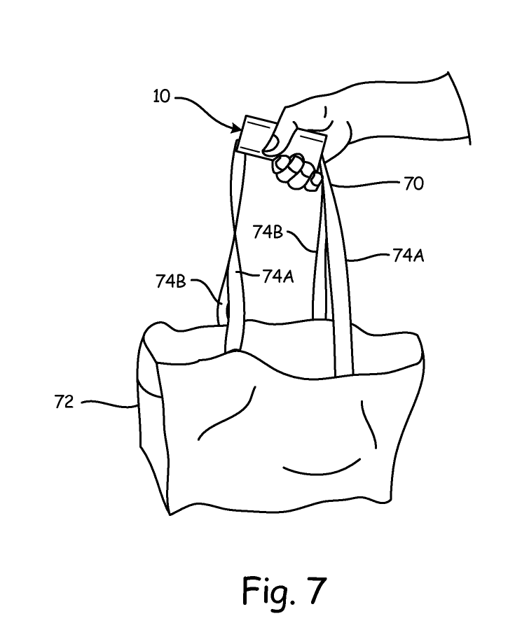

FIG. 8 shows personal grip cover 10A (which includes tubular body 12A and longitudinal slot 14A) applied to steering wheel 80 of a vehicle. FIG. 9 shows a perspective view of personal grip cover 10A. In this case, personal grip cover 10A is shown on an upper right hand side of steering wheel 80, but its location can differ depending upon personal preferences of the driver. In some cases, a driver may choose to have more than one personal grip cover applied to the steering wheel, so that the driver can grip the steering wheel at different locations and with different hands.

In the case of steering wheel 80, the location of longitudinal slot 14 can vary, because the driver is not using personal grip cover 10 for lifting. The location of longitudinal slot 14A in FIG. 8 is shown in phantom, indicating that longitudinal slot 14 is on the side of tubular body 12 that faces away from the driver. That position can differ depending upon the preference of the driver, and also may differ depending upon the cross sectional shape of the outer ring of steering wheel 80.

For use on steering wheels, the cross sectional shape of personal grip cover 10 may be circular or nearly circular to better conform with the cross sectional shape of the outer rim of steering wheel 80. In one embodiment, personal grip cover 10 has an inside diameter of 1 3/8 inches and a wall thickness of 1/4 inch. It is formed of silicone rubber with a durometer of about 50.

The circular or near circular cross section is also advantageous with exercise equipment.

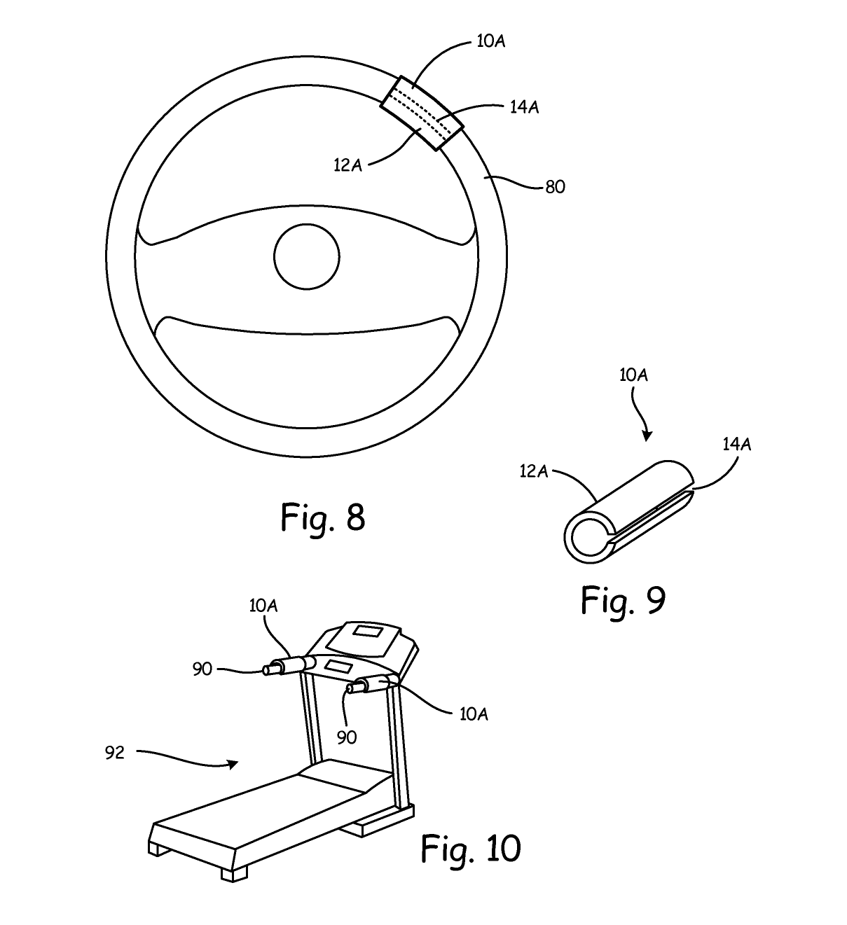

As shown in FIG. 10, personal grip cover 10A can be applied to those portions of the exercise equipment that are normally gripped while exercising. In FIG. 10, two grip covers 10A are applied to handles 90 of treadmill 92.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A personal grip cover comprising:
a tubular body of a rubber material of a durometer of about 50; and
a longitudinal slot extending from a first end to a second end of the tubular body.

2. The personal grip cover of claim 1, wherein the tubular body has a wall thickness of about 3/16 inch to about 5/16 inch, a length of about 3 inches to about 5 inches, a generally oval or kidney shaped cross section, a width of about 1 to about 1 1/4 inches, and a height of about 1 3/4 to about 2 inches.

3. The personal grip cover of claim 1, wherein the tubular body is formed of silicone rubber.

4. The personal grip cover of claim 1, wherein the tubular body has a wall thickness of about 3/16 inch to about 5/16 inch.

5. The personal grip cover of claim 4, wherein the tubular body has a generally oval or kidney shaped cross section with a hollow core.

6. The personal grip cover of claim 1, wherein the tubular body has a length of about 3 inches to about 5 inches.

7. The personal grip cover of claim 1, wherein the tubular body has a width of about 1 1/4 inches.

8. The personal grip cover of claim 1, wherein the tubular body has a height of about 2 inches.

9. The personal grip cover of claim 1, wherein the tubular body has a circular cross section.

10. The personal grip cover of claim 9, wherein the tubular body has an inner diameter of 1 3/8 inches.

11. The personal grip cover of claim 10, wherein the tubular body has a wall thickness of 1/4 inch.

12. A method comprising:
opening a personal grip cover along a longitudinal slot;
applying a tubular body of the personal grip cover over a handle, steering wheel or other hand grippable object; and
gripping the tubular body with a human hand to grip the handle, steering wheel or other hand grippable object.

13. The method of claim 12 wherein:
the tubular body is formed of a rubber material of a durometer of about 50; and
the longitudinal slot extends from a first end to a second end of the tubular body.

14. The method of claim 13, wherein the tubular body has a wall thickness of about 3/16 inch to about 5/16 inch, a length of about 3 inches to about 5 inches, a generally oval or kidney shaped cross section, a width of about 1 to about 1 1/4 inches, and a height of about 1 3/4 to about 2 inches.

15. The method of claim 12, wherein the tubular body is formed of silicone rubber.

16. The method of claim 15, wherein the tubular body has a generally oval, kidney shaped or circular cross section with a hollow core.

17. The method of claim 12, wherein the tubular body has a length of about 3 inches to about 5 inches.

18. The method of claim 12, wherein the tubular body has a circular cross section.

19. The method of claim 17, wherein the tubular body has an inner diameter of 1 3/8 inches.

20. The method of claim 12, wherein the tubular body has a wall thickness of 1/4 inch.
